(19) United States
(12) Patent Application Publication
(10) Pub. No.: US 2007/0201973 A1
(43) Pub. Date: Aug. 30, 2007

(54) Quick coupler system

(75) Inventors: Ronald McDermott, Coal Valley, IL (US); Robert N. Latour JR., Ashburnham, MA (US)

Correspondence Address: FOLEY & LARDNER LLP, 321 NORTH CLARK STREET, SUITE 2800, CHICAGO, IL, 60610-4764, US

(73) Assignee: Woods Equipment Company

(21) Appl. No.: 11/363,600

(22) Filed: Feb. 28, 2006

(51) Int. Cl. B66C 23/00

(52) U.S. Cl. 414/723

(57) ABSTRACT

A system for coupling an implement to a machine. A coupler body includes first and second opposed coupler sidewalls, each including a lock pin coupler receiving region therein, and at least one transverse member coupled to the first and second opposed side walls. An attachment member includes first and second opposed attachment member sidewalls. Each attachment sidewall includes a hook member at a first end thereof and a lock pin attachment receiving region at a second end thereof. The lock pin attachment receiving regions are configured to selectively align with the lock pin coupler receiving regions when the hook members have received a transverse member. A lock pin is sized to be accepted by each lock pin coupler receiving region and each lock pin attachment receiving region when aligned with each other.

### FIELD OF THE INVENTION

The present invention relates generally to coupling devices. More particularly, the present invention relates to coupling devices that permit the quick and easy attachment of implements to larger devices such as excavators.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Quick couplers have been widely used with excavating equipment, such as hydraulic excavators or backhoes, to allow individual pieces of equipment to be used with a variety of tools, e.g., different buckets, grapples and the like, without extended downtime for changing tools. For example, one conventional quick release hitch for attaching an implement to the arm of a hydraulic excavator comprises a pair of pivoted links, with each link having a jaw for engaging a pin on the implement. The links can be jack-knifed to engage or disengage the implement; and locking structures are provided for locking the links together when the implement has been engaged, with the locking structure preferably being a rotatable cam and/or over-center mechanism.

Conventional quick couplers typically include a pair of spaced parallel plates, with the plates defining holes for fixed attachment of the coupler to the end of a backhoe or other piece of equipment. The plates define a first slot facing generally forward to engage a first pin on the bucket or tool, and a second slot, facing generally downward (i.e., disposed at 90 degrees to the first slot) to engage a second pin on the bucket or tool. In operation, the first pin is engaged in the first slot. The coupler is then rotated about the longitudinal axis of the first pin to engage the second pin in the second slot. The coupler and tool are thereafter secured together by engagement, e.g., of a coupler gate with the second pin. This coupler gate is typically pivotally mounted to a pin on the coupler such that it pivots about a horizontal axis parallel to the longitudinal axes of the first and second slots/pins. These conventional couplers can be rendered virtually unusable by a relatively small degree of wear in the slots.

Although moderately effective, conventional coupler systems include a number of drawbacks. For example, most conventional coupler systems currently available require the use of tools such as wrenches to remove the attachment from the coupler. This both adds complexity and difficulty to the assembly and disassembly processes, as well as lengthening the amount of time required to remove and/or replace an implement. Additionally, many conventional couplers utilize a “blank hook” design that includes a wedge that presses the coupler to the attachment. The wedge is part of the coupler and forces the attachment to the coupler by tightening bolts that pass through the wedge. Once tight, the wedge acts to hold the attachment to the coupler. However, it would be advantageous for the coupler system to not include a wedge at all. In addition, conventional systems are configured such that they are unable to pick up and hold an attachment without first engaging wedges and other items, and the attachments are often arranged such that the weight of the attachment and implement hinder, rather than aid in, the alignment of the coupler and the attachment.

### SUMMARY OF THE INVENTION

The present invention provides a system for coupling an implement to a machine. A coupler body includes first and second opposed coupler sidewalls, each including a lock pin coupler receiving region therein, and at least one transverse member coupled to the first and second opposed coupler sidewalls. An attachment member includes first and second opposed attachment sidewalls. Each attachment sidewall includes a hook member at a first end thereof and a lock pin attachment receiving region at a second end thereof. The lock pin attachment receiving regions are configured to selectively align with the lock pin coupler receiving regions when the hook members have received a transverse member. A lock pin is sized to be accepted by each lock pin coupler receiving region and each lock pin attachment receiving region when aligned with each other. When each hook member has received a transverse member and the lock pin attachment receiving regions are aligned with the lock pin coupler receiving regions, the lock pin is capable of mating with each of the lock pin attachment receiving regions and each of the lock pin coupler receiving regions, securing the coupler body to the attachment member. With this system, and unlike conventional systems, the coupler allows the attachment to be picked up and aligned before the locking pin is engaged.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1(a) is a perspective view of an unattached bucket and an excavator arm with an improved quick coupler according to one embodiment of the present invention;

FIG. 1(b) is another perspective view of an unattached bucket and improved quick coupler without an excavator shown;

FIGS. 2(a)-2(c) are side elevation views of the quick coupler of FIGS. 1(a) and 1(b), illustrating the attachment of the tool to the quick coupler;

FIG. 3 is a front end view illustrating the quick coupler of FIGS. 1(a) and 1(b) with the attachment in the latched position; and

FIG. 4 is a side elevation view that shows a coupler according to one embodiment of the present invention.

### DETAILED DESCRIPTION OF THE PREFERRED EMBODIMENTS

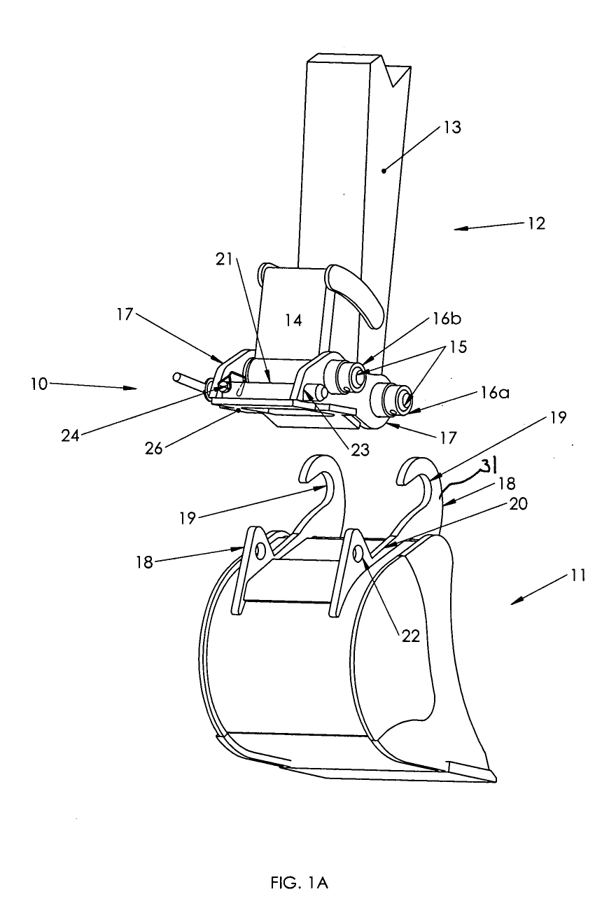

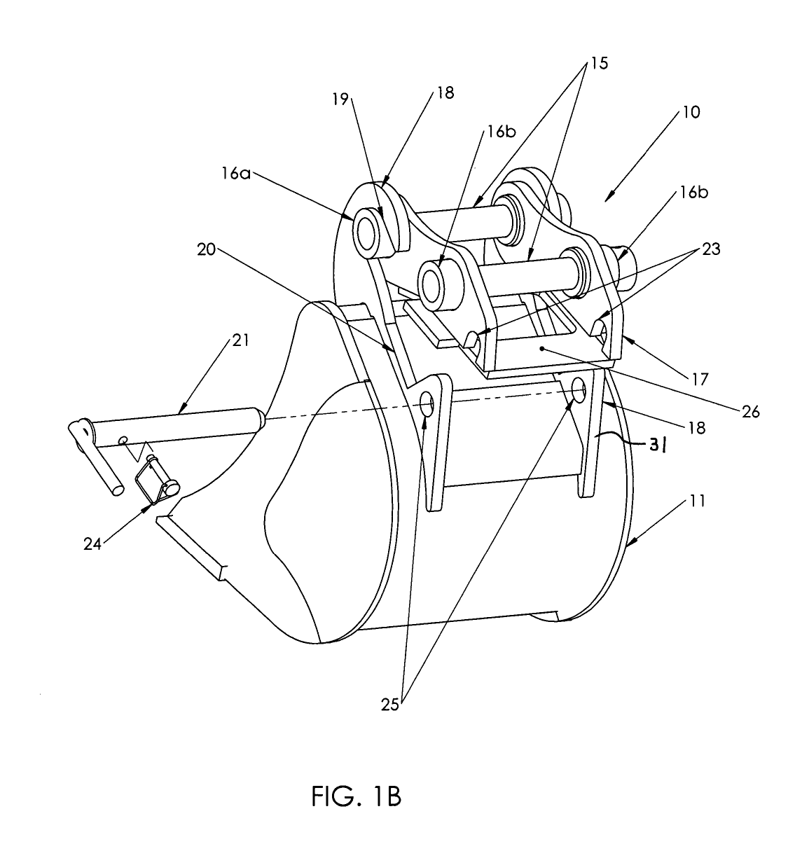

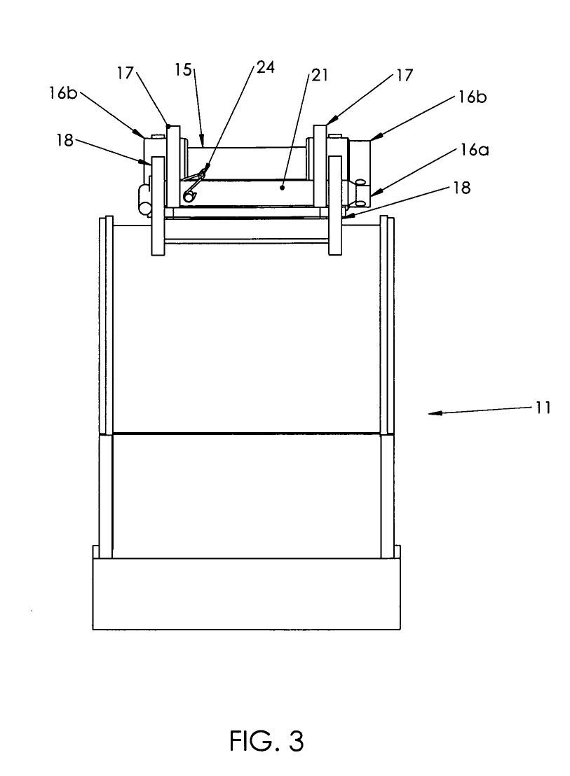

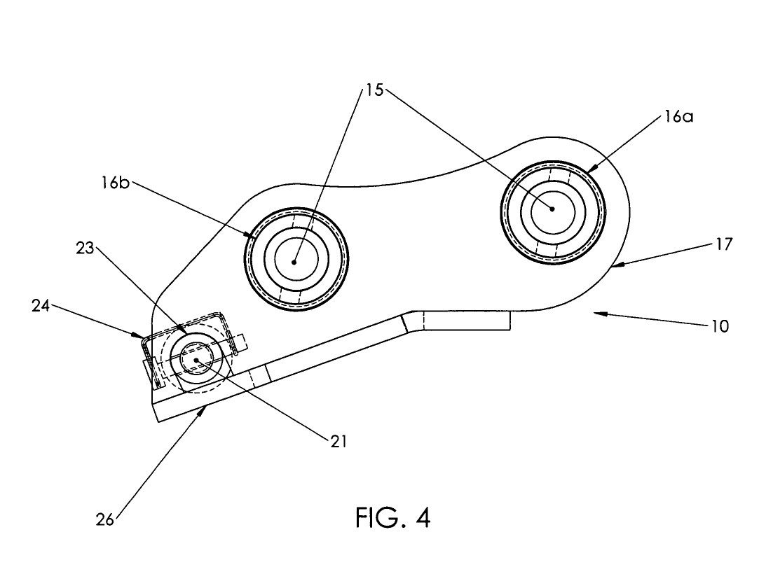

An improved coupler system constructed in accordance with the principles of the present invention is shown and described in FIGS. 1-4. A coupler 10 is securely attached to an arm assembly of an excavator 12. An implement 11 is shown in FIG. 1(a) but is not attached to the coupler 10. The quick coupler 10 permits attachment of a range of tools, including but not limited to buckets, grapples, rippers, compaction wheels, compaction plates, hammers, trimmers, grinders, crushers, shears, saws, screens and the like to a backhoe or other excavator or similar machine.

The coupler 10 is pivotally attached to an excavator dipper stick 13 and a link 14 by a plurality of pins 15. The plurality of transverse members in the form of pins 15 run through bosses 16a and 16b on the coupler 10 and pivot holes in the dipper stick 13 and the link 14. According to a preferred embodiment of the invention, the coupler 10 includes a pair of pins 15. However it is possible that a different number of pins 15 could be used. The coupler 10, according to one embodiment of the invention, comprises a pair of opposed coupler sidewalls 17 including a plurality of generally parallel front and rear coupler pin bosses 16a and 16b into which the plurality of pins 15 are mounted.

The implement 11 is coupled to an attachment 31 and includes a plurality of generally opposed attachment sidewalls 18 on the top end thereof. The attachment 31 can either be integrally formed with the implement 11, or it can be a separate component. The plurality of generally opposed attachment sidewalls 18 on the attachment 31 each include a hook portion 19. The hook portion 19 of each of the opposed attachment sidewalls 18 captures the front coupler pin bosses 16a that attaches to the dipper stick 13. In the embodiment shown in the attached figures, the hook portions 19 open towards the “back” side of the implement 11. The direction of the hook portions 29 allow for strength and coupler-to-attachment connection tightness advantages based upon applied forces during normal attachment material engagement conditions.

The coupler 10 is secured to the attachment 31 by way of a lock pin 21. The lock pin 21 secures the coupler 10 by sliding through a plurality of lock pin coupler receiving regions 23 located on the opposed coupler sidewalls 17 of the coupler 10, as well as sliding through lock pin attachment receiving regions 22 on the opposed attachment sidewalls 18 of the attachment 31 that align with the plurality of lock pin coupler receiving regions 23 on the coupler 10. In the embodiment shown in the attached figures, both the lock pin coupler receiving regions 23 and the lock pin attachment receiving regions 22 comprise bores formed within the respective coupler sidewalls 17 and attachment sidewalls 18, respectively. However, it is possible that other types of openings (such as slots) or other receiving regions may be used. It should also be noted that the term “bore” can refer to holes of different shapes and should not be interpreted to be limited to circles or other particular shapes. The lock pin 21 is secured in place by way of a retainer pin 24. The retainer pin 24 latches the lock pin 21 through the lock pin coupler receiving regions 23 on the coupler 10 and the attachment lock pin attachment receiving regions 22 on the attachment 31. In the embodiment shown in FIGS. 1(a)-4, the lock pin 21, when secured, is substantially parallel to the pins 15. In the embodiment depicted in the attached figures, the lock pin 21 is positioned, when attached to the coupler 10 and the attachment 31, at an end of the attachment 31 substantially opposite the hook portion 19. However, by altering the position of the lock pin coupler receiving regions 23 and the lock pin attachment receiving regions 22, the lock pin 21 could be located in a different position.

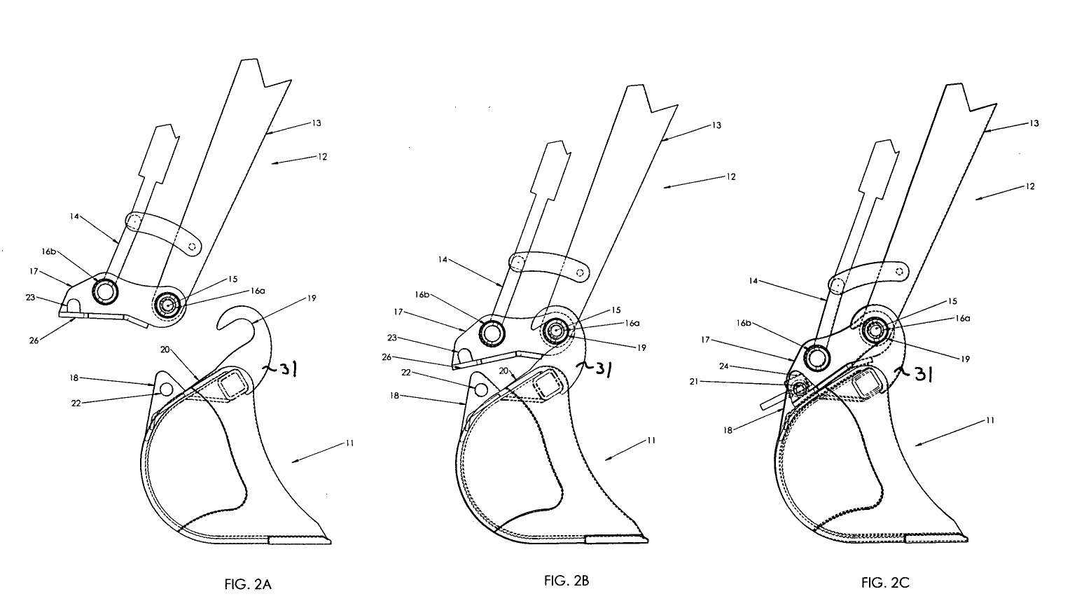

Referring to FIGS. 2(a)-2(c), the operation of the coupler 10 of FIG. 1 is shown in three stages of connection to an attachment 31. FIG. 2(a) shows the coupler 10 attached to the arm of an excavator 12. In FIG. 2(a), the attachment 31 is shown ready to be coupled to the coupler 10. FIG. 2(b) shows the pin boss 16b of the coupler 10 engaged in the hook portion 19 of the attachment 31. From this point, the coupler 10 is rotated on the excavator dipper stick 13 into the position shown in FIG. 2(c), where the coupler 10 is essentially resting upon the attachment 31. As shown in FIG. 2(c), at this point the lock pin coupler receiving regions 23 align with the lock pin attachment receiving regions 22. In this position, the lock pin 21 is inserted through the lock pin coupler receiving regions 23 on the coupler 10 and the lock pin attachment receiving regions 22 on the attachment 31. The lock pin 21 is secured to the coupler 10 by the retainer pin 24. It is important to note that, even before the lock pin is secured to the coupler 10 and the attachment 31, once the hook portion 19 of each of the opposed attachment sidewalls 18 has captured the front coupler pin bosses 16a, the attachment 31, and therefore the attached implement 11, can be lifted by the excavator 12 or other machine for proper aligning. This is an improvement over conventional systems. Additionally, the positioning of the hook portions 19 allows for the weight of the attachment 31 to aid in completing the engagement of the attachment 31 and the coupler 11. This is also an improvement over conventional systems, where the attachment and implement weight actually hinders the aligning process.

A number of embodiments of the invention have been described. Nevertheless, it will be understood by those skilled in the art that various modifications may be made without departing from the spirit and scope of the invention. For example, rather than having the lock pin 21 manually actuated, the lock pin 21 may be actuated by remote control, e.g., from the cab of the excavator, using hydraulic or pneumatic cylinders to move the latch lever. Many changes and modifications within the scope of the present invention may therefore be made without departing from the spirit of the invention, and the invention includes all such changes and modifications.

What is claimed is:

1. A system for coupling an implement to a machine, comprising:
a coupler body including:
first and second opposed coupler sidewalls, each including a lock pin coupler receiving region therein, and
at least one transverse member coupled to the first and second opposed side walls;
an attachment member including first and second opposed attachment member sidewalls, each attachment sidewall including a hook member at a first end thereof and a lock pin attachment receiving region at a second end thereof, the lock pin attachment receiving regions configured to selectively align with the lock pin coupler receiving regions when the hook members have received a transverse member; and
a lock pin sized to be accepted by each lock pin coupler receiving region and each lock pin attachment receiving region when aligned with each other,
wherein when each hook member has received a transverse member and the lock pin attachment receiving regions are aligned with the lock pin coupler receiving regions, the lock pin is capable of mating with each of the lock pin attachment receiving regions and each of the lock pin coupler receiving regions, securing the coupler body to the attachment member.

2. The system of claim 1, wherein each of the at least one transverse member comprises:
a pin extending between the first and second opposed coupler sidewalls;
a first pin boss for operatively connecting the pin to the first coupler sidewall; and
a second pin boss for operatively connecting the pin to the second coupler sidewall.

3. The system of claim 1, wherein when each hook member has received a transverse member, the implement can be raised by the machine without first securing the attachment member to the coupler body via the lock pin.

4. The system of claim 1, wherein each hook member is arranged such that the weight of the attachment member and the implement work in favor of aligning the lock pin attachment receiving regions and the lock pin coupler receiving regions.

5. The system of claim 1, wherein the attachment member is coupled to a grapple.

6. The system of claim 1, further comprising a safety pin configured to selectively inhibit the lock pin from being released from the lock pin coupler receiving regions and the lock pin attachment receiving regions.

7. The system of claim 1, wherein each lock pin attachment receiving region comprises a bore formed within one of the attachment side walls.

8. A system for coupling an implement to a machine, comprising:
a coupler body including:
first and second opposed coupler sidewalls, each including a lock pin coupler receiving region therein, and
first and second transverse members each coupled to the first and second opposed coupler side walls;
an attachment member including first and second opposed attachment member sidewalls, each attachment member sidewall including a hook member at a first end thereof and a lock pin attachment receiving region, the lock pin attachment receiving regions configured to selectively align with the lock pin coupler receiving regions when the hook members have received the first transverse member; and
a lock pin sized to be accepted by each lock pin coupler receiving region and each lock pin attachment receiving region when aligned with each other,
wherein when each hook member has received the first transverse member and the lock pin attachment receiving regions are aligned with the lock pin coupler receiving regions, the lock pin is capable of mating with each of the lock pin attachment receiving regions and each of the lock pin coupler receiving regions, securing the coupler body to the attachment member.

9. The system of claim 8, wherein each of the at least one transverse member comprises:
a pin extending between the first and second opposed coupler sidewalls;
a first pin boss for operatively connecting the pin to the first coupler sidewall; and
a second pin boss for operatively connecting the pin to the second coupler sidewall.

10. The system of claim 8, further comprising a safety pin configured to selectively inhibit the lock pin from being released from the lock pin coupler receiving regions and the lock pin attachment receiving regions.

11. The system of claim 8, wherein each lock pin attachment receiving region comprises a bore formed within one of the attachment side walls.

12. The system of claim 8, wherein when each hook member has received the first transverse member, the implement can be raised by the machine without first securing the attachment member to the coupler body via the lock pin.

13. The system of claim 8, wherein each hook member is arranged such that the weight of the attachment member and the implement work in favor of aligning the lock pin attachment receiving regions and the lock pin coupler receiving regions.

14. A coupling system, comprising:
a coupler body including:
first and second opposed coupler sidewalls, each including a lock pin coupler receiving region therein,
at least one transverse member coupled to the first and second opposed coupler side walls, and
a plurality of bosses for operatively connecting the at least one transverse member to the first and second opposed sidewalls; and
an attachment member including first and second opposed attachment member sidewalls, each attachment member sidewall including a hook member and a lock pin attachment receiving region, the lock pin attachment receiving regions configured to selectively align with the lock pin coupler receiving regions when the hook members have received the first transverse member; and
a lock pin sized to be accepted by each lock pin coupler receiving region and each lock pin attachment receiving region when aligned with each other.

15. The coupling system of claim 14, wherein each lock pin attachment receiving region comprises a bore formed within one of the attachment side walls.

16. The coupling system of claim 15, further comprising a safety pin configured to selectively inhibit the lock pin from being released from the lock pin coupler receiving regions and the lock pin attachment receiving regions.

17. The coupling system of claim 14, wherein the at least one transverse member comprises two transverse members.

18. The coupling system of claim 14, further comprising an implement coupled to the attachment member.

19. The coupling system of claim 18, wherein when each hook member has received the first transverse member, the implement can be raised by the machine without first securing the attachment member to the coupler body via the lock pin.

20. The coupling system of claim 18, wherein each hook member is arranged such that the weight of the attachment member and the implement work in favor of aligning the lock pin attachment receiving regions and the lock pin coupler receiving regions.
